(19) United States
(12) Patent Application Publication
(10) Pub. No.: US 2024/0399676 A1
(43) Pub. Date: Dec. 5, 2024

(54) TOOL FOR AN ULTRASONIC WELDING DEVICE AND ASSOCIATED METHOD

(71) Applicant: HERRMANN ULTRASCHALLTECHNIK GMBH & CO. KG, Karlsbad (DE)

(72) Inventors: Andreas RUNCK, Karlsruhe (DE); Valentin BUCHTY, Ettlingen (DE)

(21) Appl. No.: 18/700,867

(22) PCT Filed: Oct. 4, 2022
(86) PCT No.: PCT/EP2022/077553

§ 371 Date: Apr. 12, 2024

(30) Foreign Application Priority Data
Oct. 14, 2021 (DE) 102021126679.3

(51) Int. Cl. B29C 65/00; B29C 65/08; B29K 23/00

(52) U.S. Cl. CPC B29C 66/81422; B29C 65/088; B29C 66/81423; B29C 66/81425; B29K 2023/12

(57) ABSTRACT

A tool for an ultrasonic sealing device with a base surface, wherein the base surface has a first elevation which extends from the base surface in a direction perpendicular to the base surface, wherein the first elevation has a first partial sealing surface, wherein the first partial sealing surface has a second elevation which extends from the first partial sealing surface in a direction perpendicular to the first partial sealing surface, wherein the second elevation has a second partial sealing surface. In order to provide a tool with which aluminum-free plastic materials, in particular polypropylene sealing layers, can also be reliably sealed, it is proposed according to the invention that both the first partial sealing surface and the second partial sealing surface are provided for processing a material.

### FIELD OF THE INVENTION

The present invention relates to a tool for an ultrasonic sealing device having a base surface, the base surface having a first elevation extending from the base surface with a height H1 in a direction perpendicular to the base surface, the first elevation having a first partial sealing surface, the first partial sealing surface having a second elevation extending from the first partial sealing surface with a height H2 in a direction perpendicular to the first partial sealing surface, the second elevation having a second partial sealing surface.

The present invention also relates to an ultrasonic processing device and a method for ultrasonic processing.

### BACKGROUND OF THE INVENTION

Ultrasonic welding has been an established process for some time when it comes to joining thermoplastics together in a form-fit or material-fit manner. The areas of application range from the automotive and electrical industries to the packaging, medical and hygiene industries.

Ultrasonic welding devices typically have an ultrasonic generator, a converter, a sonotrode and a counter tool. The ultrasonic generator generates a high voltage at the desired ultrasonic frequency from an applied mains voltage, which is then converted into a mechanical longitudinal oscillation in the converter using the inverse piezoelectric effect and transmitted to the sonotrode. As the actual active welding tool, the sonotrode then transmits the mechanical vibration to the material to be processed. The sonotrode has a sealing surface via which the sonotrode comes into contact with the material to be processed. In order to generate pressure in the material, a counter tool is usually arranged on the opposite side of the sonotrode, which also has a sealing surface that comes into contact with the material to be processed. The material is therefore guided between the sealing surface of the sonotrode and the sealing surface of the counter tool.

When the invention refers to a tool, this can mean both a tool in the form of a sonotrode and a tool in the form of the counter tool of an ultrasonic welding device. The tool according to the invention is suitable for both components of an ultrasonic welding device, as will be shown further below.

The mechanical vibration with frequencies in the ultrasonic range generates frictional heat in the material to be processed and stimulates the molecules in the material to be processed to move. As a result, the material to be processed softens and begins to melt, so that the components to be joined bond together when a certain amount of pressure is applied to the components over a certain period of time. The components are then firmly bonded together at molecular level.

Depending on the application, certain requirements are placed on the weld seam to be created. For example, both the sealing surface of the sonotrode and the sealing surface of the counter tool can have certain contours that produce weld seams with a specific pattern.

However, the welding result also depends largely on the type of material being processed. In the packaging industry in particular, plastic materials are used that exhibit a sudden drop in viscosity during melting, meaning that uncontrolled melt splashes can occur during the ultrasonic machining process. This is the case, for example, with aluminum-free materials with polypropylene sealing layers. These uncontrolled melt splashes lead to damage to the printed image on the one hand and cause microleaks on the other.

To avoid these disadvantages, it is possible to set parameters such as pressure and ultrasonic frequency during the ultrasonic machining process in such a way that such melt splashes are prevented. In this case, the pressure or the temperature generated in the material to be processed is kept low. However, there is a high risk of leaks, as no sufficiently stable weld seam is produced between the components to be joined. This problem is exacerbated if, as is often the case in the packaging industry, the seam area is contaminated with the product to be packaged. In this case, the energy introduced into the material by ultrasonic processing is not sufficient to melt it to such an extent that a stable weld seam is created.

However, if process parameters and mold geometries are used that ensure sufficient strength, this leads to an excessive, turbulent melt flow that cannot be controlled, as mentioned above.

### SUMMARY OF THE INVENTION

The present invention is therefore based on the problem of providing a tool or an ultrasonic processing device or a method for ultrasonic processing with which aluminum-free plastic materials, in particular polypropylene sealing layers, can also be reliably welded.

According to the invention, this problem is solved by a tool of the type mentioned at the beginning, wherein both the first partial sealing surface and the second partial sealing surface are intended to process a preferably two- or multi-layer material during operation of the ultrasonic welding device.

According to the invention, it is thus provided that only the first partial sealing surface of the first elevation and the second partial sealing surface of the second elevation come into contact with a sealing surface of a second tool corresponding to the tool, for example a sonotrode, in such a way that the material to be processed is only welded in these areas. Conversely, the tool can also be a sonotrode that comes into contact with a sealing surface of a counter tool of any design in order to process the material in the said areas.

The tool according to the invention is designed in such a way that little melt is produced with the second partial sealing surface of the second elevation, so that less melt splashes are produced. At the same time, the tightness of the weld seam is increased with the aid of the first partial sealing surface of the first elevation, in that the first partial sealing surface is also pressed onto the material to be processed. Any melt splashes that occur due to the second partial sealing surface of the second elevation are additionally pressed by the first partial sealing surface of the first elevation. In this way, the melt flow can be better controlled and a homogeneously closed melt front is created.

The height H1 is defined by a line perpendicular to the base surface that connects the point on the base surface with the point on the first partial sealing surface that are the greatest possible distance apart. The same definition applies to the height H2 of the second elevation. Here, the height H2 is defined by the longest connecting line perpendicular to the base surface between two points on the first and second partial sealing surfaces.

According to the invention, it is further provided that the second elevation is arranged on the first partial sealing surface of the first elevation. As a result, the second elevation cannot penetrate as deeply into the material to be processed, since the first partial sealing surface, which is preferably significantly larger than the second partial sealing surface, forms a kind of stop. This also prevents excessive melt generation or cutting of the material to be processed due to a sharp geometry of the second partial sealing surface. In one embodiment, the height H2 of the second elevation is selected so that it is less than the total thickness of the two- or multi-layer material to be processed.

In one embodiment, the second elevation in a first plane perpendicular to the base surface has a part-circular cross-section with a radius r₂, whereby preferably the radius r₂ of the part-circular cross-section is at most 2 mm, particularly preferably at most 1.5 mm. Both the part-circular cross-section and the smaller radius compared to conventional tool structures offer the advantage that, on the one hand, melt is produced more easily due to improved energy focusing and, on the other hand, the risk of material damage is reduced, as the melt volume produced is low and can be better controlled, so that unwanted melt splashes can be more reliably avoided.

In a further embodiment, the first partial sealing surface is either flat, preferably parallel to the base surface, or curved with a radius of curvature r₁ convex to the base surface. In a preferred embodiment, r₂ is smaller than r₁.

In a further embodiment, the first elevation has a trapezoidal cross-section in a first plane perpendicular to the base surface. For the purposes of the application, trapezoidal means a quadrilateral in which only two of the four sides are parallel to one another. The sides of the trapezoidal cross-section, i.e. the sides which are not parallel to one another, preferably run towards one another when viewed from the base surface, so that the base side of the trapezoidal cross-section, which forms the first partial sealing surface, is shorter than the base side of the trapezoidal cross-section, which is arranged on the base surface.

The trapezoidal cross-section of the first elevation has the advantage that there are fewer sharp edges on the first elevation that could damage the material to be processed. At the same time, the first partial sealing surface of the first elevation is therefore flat, i.e. in contrast to the second partial sealing surface of the second elevation, it has no curvatures. In this way, any melt splashes that may occur can be pressed particularly effectively.

In a further embodiment, the first elevation and/or the second elevation have an extension in a transverse direction perpendicular to the first plane which is larger than an extension in a longitudinal direction parallel to the first plane. Thus, the first and second elevation is not a punctiform elevation on the base surface of the tool, but a planar, for example rib-shaped, elevation which extends over at least a part of the base surface in the transverse direction. Preferably, the first and second elevations extend over such a width of the base surface that corresponds to the width of the material to be processed, so that a continuous weld seam is produced by the tool according to the invention. However, it is understood that other configurations of the first and second elevation in the longitudinal and transverse directions are also possible if other welding patterns are to be achieved.

In a further embodiment, exactly one second elevation is arranged on the first partial sealing surface of the first elevation, the second elevation preferably being arranged centrally on the first partial sealing surface.

The arrangement of a second elevation centrally on the first partial sealing surface offers the advantage that any melt splashes that occur can also be pressed particularly effectively, since, viewed in the first plane, an equal proportion of the first partial sealing surface is arranged on both sides of the second elevation.

In a further embodiment, a length of the shorter base side of the trapezoidal cross-section of the first elevation corresponds to an extension of the first partial sealing surface in the first plane. The first partial sealing surface thus extends over the full extent of the first elevation in the first plane. In other words, however, only over the surface part of the trapezoidal cross-section, which is arranged parallel to the base surface of the tool.

In a further embodiment, the height H2 of the second elevation is less than or equal to the height H1 of the first elevation. This offers the advantage that the second elevation cannot penetrate so deeply into the material to be processed that it would damage the material to be processed. The parts of the first partial sealing surface to the side of the second elevation therefore prevent the second elevation from penetrating too deeply into the material layer to be processed. This prevents excessive melt generation on the one hand and damage to the material layer on the other. At the same time, the greater height H1 of the first elevation ensures that the base surface of the tool, which is not part of the first or second partial sealing surface, does not contribute to the processing of the material using ultrasound.

In particular, also for the aforementioned purpose, the height H2 in one embodiment is selected to be smaller than a total thickness of the two- or multi-layer material to be processed, wherein the height H1 is selected such that the sum of the height H1 and the height H2 is larger than the total thickness of the two- or multi-layer material.

In a further embodiment, an extension of the second partial sealing surface in a first plane perpendicular to the base surface is smaller than an extension of the first partial sealing surface in the first plane. In other words, this means that the first elevation in the first plane is longer than the second elevation, so that parts of the first partial sealing surface are located to the side of the second elevation. These parts of the first partial sealing surface ensure effective compression of the resulting melt splashes.

In a further embodiment, a third elevation is provided on the base surface, which elevation extends with a height H3 in a direction perpendicular to the base surface from the base surface, wherein the third elevation is neither arranged on the first partial sealing surface nor on the second partial sealing surface and is intended to come into contact with the material to be processed, but not to carry out processing of the material, the height H3 of the third elevation corresponding at least to the sum of the height H1 of the first elevation and the height H2 of the second elevation and preferably being larger than the sum of the height H1 of the first elevation and the height H2 of the second elevation.

The third elevation merely serves to fix the layers of material to be processed by engaging in a corresponding indentation on the opposite sealing surface of the corresponding second tool, for example the sonotrode, during the ultrasonic welding process. This causes the material to be processed to be clamped between the tool and the corresponding second tool so that the material cannot be displaced during the ultrasonic welding process. However, the pressure exerted by the third elevation on the material to be processed is not sufficient to achieve ultrasonic processing.

By holding the material to be processed, however, a more precise weld seam can be produced using the first and second partial sealing surfaces.

As already mentioned at the beginning, the tool according to the invention can be used as a sonotrode in one embodiment or as a counter tool in another embodiment.

The problem underlying the invention is further solved by an ultrasonic welding device having an ultrasonic generator, a converter, a sonotrode and a counter tool, the converter being set up and connected to the sonotrode in such a way that, during operation of the ultrasonic welding device, the converter converts an ultrasonic frequency generated by the ultrasonic generator into a mechanical vibration and transmits it to the sonotrode, wherein the sonotrode and the counter tool each have a sealing surface which comes into contact with the material to be processed during operation of the ultrasonic welding device, wherein the sealing surface of the sonotrode is opposite the sealing surface of the counter tool, wherein a material to be processed can be arranged between the sealing surface of the sonotrode and the sealing surface of the counter tool, wherein either the sonotrode or the counter tool is a tool according to one of the previously described embodiments.

According to the invention, it is provided that the sonotrode clamps the material to be processed between the sealing surface of the sonotrode and the sealing surface of the counter tool in such a way that sufficient pressure is only generated in the area of the first partial sealing surface and the second partial sealing surface in order to process the material to be processed with ultrasound. In all other areas of the sealing surface of the sonotrode and the sealing surface of the counter tool, no ultrasonic processing takes place. It is understood that if the tool according to the invention is a counter tool, the sealing surface of the counter tool corresponds to the base surface of the tool with the corresponding partial sealing surfaces and if the tool according to the invention is a sonotrode, the sealing surface of the sonotrode corresponds to the base surface of the tool with the corresponding partial sealing surfaces. The tool, which does not have the sealing surface structure of the tool according to the invention, can alternatively also be described as a second tool corresponding to the tool.

The problem underlying the invention is further solved by a method for processing a material, preferably a two- or multi-layer material, with ultrasound, the method comprising the following steps:
a. provide a sonotrode with a sealing surface,
b. providing a counter tool with a sealing surface, wherein either the sonotrode or the counter tool is a tool according to one of the previously described embodiments,
c. guiding the material between the sealing surface of the sonotrode and the sealing surface of the counter tool in a feed direction,
d. excitation of the sonotrode with an ultrasonic vibration so that the sonotrode applies pressure to the material and the sealing surface of the counter tool via the sealing surface of the sonotrode, so that the material in the area of the first and second partial sealing surface of the tool is processed with ultrasound.

In one embodiment of the method according to the invention, the tool according to the invention is arranged such that the first plane is perpendicular to the feed direction of the material, i.e. perpendicular to the direction in which the material is moved between the second tool and the tool. For ultrasonic processing, the movement of the material is preferably stopped briefly before the material is fed further in order to produce another weld seam at a different position of the material.

The tool according to the invention can therefore be used to produce sealing seams that are parallel to a feed direction of the material to be processed. This is used, for example, in the packaging industry, where individual products are to be packaged in sections in a bag- or web-shaped material.

Further advantages, features and possible applications of the present invention will become clear from the following description of an embodiment of the invention and the associated figures. Identical elements are designated by identical reference signs.

### BRIEF DESCRIPTION OF THE DRAWINGS

FIG. 1 shows a schematic representation of a cross-section of an embodiment of the tool according to the invention.

FIG. 2 shows a schematic section of a cross-section of an embodiment of the ultrasonic processing device according to the invention.

### DETAILED DESCRIPTION OF THE INVENTION

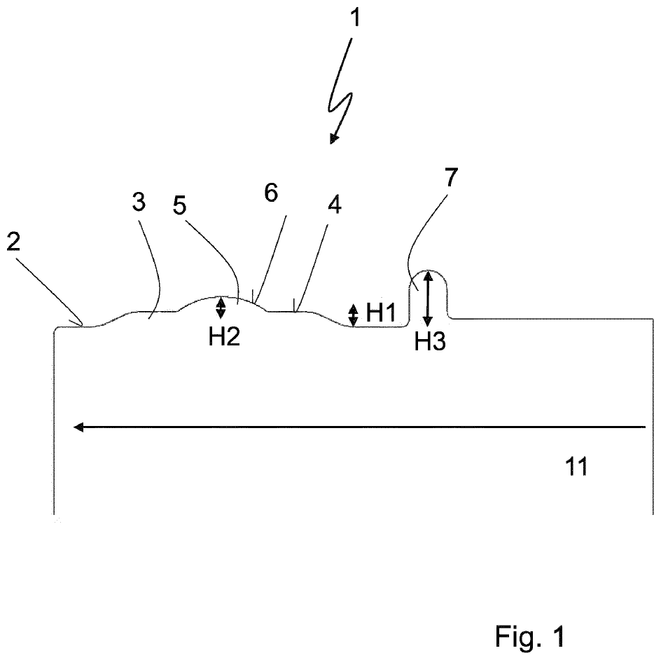

FIG. 1 shows a cross-section of the tool 1 according to the invention in the first plane. The tool 1 has a base surface 2, wherein a first elevation 3 with a height H1 is arranged on the base surface 2, wherein the first elevation 3 has a first partial sealing surface 4 in a direction perpendicular to the sealing surface 2, which extends parallel to the base surface 2. The first elevation 3 also has a trapezoidal cross-section in the plane shown in FIG. 1 perpendicular to the base surface.

A second elevation 5 is arranged exactly in the center of the first partial sealing surface 4, which extends with a height H2 in a direction perpendicular to the first partial sealing surface 4 from the first partial sealing surface 4. The second elevation 5 has a second partial sealing surface 6. While the first partial sealing surface 4 extends parallel to the base surface 2 of the tool 1, i.e. is flat, the second partial sealing surface 6 is curved, since the second elevation 5 has a part-circular cross-section. In the embodiment shown, a radius of the part-circular cross-section is 1.5 mm. The height H2 of the second elevation 5 is, for example, 0.14 mm for a 0.2 mm thick material to be processed, whereby the height H1 is larger and is selected in such a way that the base surface does not come into contact with the material to be processed during the welding process. This is guaranteed if the sum of height H1 and H2 is larger than the total thickness of the two-layer material to be processed.

The second elevation 5 is arranged centrally on the first partial sealing surface 4 of the first elevation 3, so that a part of the first partial sealing surface 4 remains to the side of the second elevation 5, the extent of which in the plane shown in FIG. 1 is 1 mm.

Furthermore, the base surface 2 of the tool 1 has a third elevation 7, which extends from the base surface 2 with a height H3 in a direction perpendicular to the base surface 2. The third elevation 7 is arranged neither on the first partial sealing surface 4 nor on the second partial sealing surface 6, but in the longitudinal direction 11 next to the first elevation 3.

The third elevation 7 has a height H3 that is larger than the sum of the height H2 of the second elevation 5 and the height H1 of the first elevation 3.

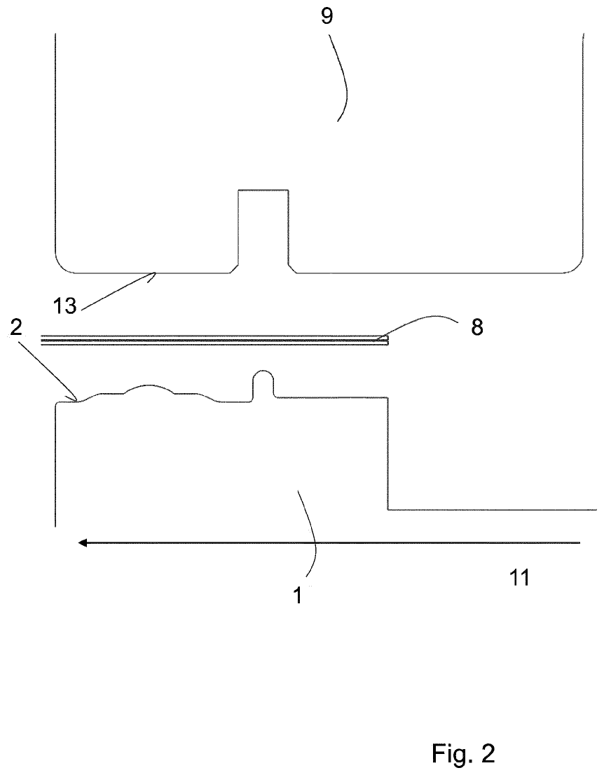

The third elevation 7 clamps a material 8 to be processed between the tool 1, in this case a counter tool, and a second tool 9 corresponding to the tool 1, in this case a sonotrode 9 for fixing when ultrasonic processing takes place (see FIG. 2).

FIG. 2 shows how a material 8 to be processed is arranged between the sonotrode 9 and the counter tool 1 according to the invention. The material is guided in a feed direction 12, which corresponds to the transverse direction 10 and extends into the sheet plane. Both sonotrode 9 and counter tool 1 extend in a transverse direction 10, which in the embodiment shown in FIGS. 1 and 2 extends into the plane of the sheet. The cross-section of the counter tool 1 shown in FIG. 1 remains constant over a width that corresponds to a width of the material 8.

The sonotrode 9 is pressed onto the material 8 to be processed with such pressure that both the first partial sealing surface 4 and the second partial sealing surface 6 come into contact with the material to be processed in such a way that ultrasonic processing takes place in the area of the first partial sealing surface 4 and the second partial sealing surface 6.

No ultrasonic processing takes place in any other areas of the sealing surface 13 of the sonotrode 9 and the base surface 2 of the counter tool 1.

In this way, aluminum-free plastic materials can also be welded together without the resulting molten splashes impairing the sealing quality of the weld seam.

### REFERENCE SIGNS

1 Tool counter tool
2 Base area of the tool
3 First elevation
4 First partial sealing surface
5 Second elevation
6 Second partial sealing surface
7 Third elevation
8 Material
9 Second tool/sonotrode
10 Transverse direction
11 Longitudinal direction
12 Feed direction
13 Sealing surface of the sonotrode

What is claimed is:

1. A tool for an ultrasonic sealing device, comprising: a base surface, the base surface having a first elevation which extends with a height H1 in a direction perpendicular to the base surface from the base surface, the first elevation having a first partial sealing surface, the first partial sealing surface having a second elevation which extends with a height H2 in a direction perpendicular to the base surface from the first partial sealing surface, the second elevation having a second partial sealing surface,
wherein both the first partial sealing surface and the second partial sealing surface are intended to process a preferably two-layered or multilayered material during operation of the ultrasonic sealing device, and
wherein the second elevation in a first plane perpendicular to the base surface has a part-circular cross-section with a radius r₂.

2. The tool according to claim 1, wherein the radius r₂ of the part-circular cross-section is at most 2 mm, particularly preferably at most 1.5 mm.

3. The tool according to claim 1, wherein the first partial sealing surface of the first elevation is either flat, preferably parallel to the base surface, or is curved with a radius of curvature r₁ convex to the base surface, wherein preferably the radius r₁ is greater than the radius r₂ of the second partial sealing surface.

4. The tool according to claim 1, wherein the first elevation has a trapezoidal cross-section in a first plane perpendicular to the base surface.

5. The tool according to claim 2, wherein the first elevation and/or the second elevation have an extension in a transverse direction perpendicular to the first plane which is larger than an extension in a longitudinal direction parallel to the first plane.

6. The tool according to claim 1, wherein exactly one second elevation is arranged on the first partial sealing surface of the first elevation, wherein preferably the second elevation is arranged centrally on the first partial sealing surface.

7. The tool according to claim 4, wherein a length of the shorter base side of the trapezoidal cross-section of the first elevation corresponds to an extension of the first partial sealing surface in the first plane.

8. The tool according to claim 1, wherein the height H2 of the second elevation is less than or equal to the height H1 of the first elevation.

9. The tool according to claim 1, wherein an extension of the second partial sealing surface in a first plane perpendicular to the base surface is smaller than an extension of the first partial sealing surface in the first plane.

10. The tool according to claim 1, wherein a third elevation is provided on the base surface, wherein the third elevation extends with a height H3 in a direction perpendicular to the base surface from the base surface, wherein the third elevation is arranged neither on the first partial sealing surface nor on the second partial sealing surface and is intended to come into contact with the material to be processed, but not to carry out processing of the material, wherein the height H3 of the third elevation corresponds at least to the sum of the height H1 of the first elevation and the height H2 of the second elevation and is preferably larger than the sum of the height H1 of the first elevation and the height H2 of the second elevation.

11. The tool according to claim 1, wherein the tool is a sonotrode or an anvil of an ultrasonic welding device.

12. An ultrasonic welding device, comprising: an ultrasonic generator, a converter, a sonotrode and a counter tool, the converter being set up and connected to the sonotrode in such a way that the converter converts an ultrasonic frequency generated by the ultrasonic generator into a mechanical vibration during operation of the ultrasonic welding device and transmits it to the sonotrode, wherein the sonotrode and the counter tool each have a sealing surface, which comes into contact with the material to be processed during operation of the ultrasonic welding device, wherein the sealing surface of the sonotrode is opposite the sealing surface of the counter tool, wherein between the sealing surface of the sonotrode and the sealing surface of the counter tool a material to be processed can be arranged, wherein either the sonotrode or the counter tool is the tool according to claim 1.

13. A method for processing a material, preferably a two- or multi-layer material, with ultrasound, comprising the steps of;
a. providing a sonotrode with a sealing surface,
b. providing a counter tool with a sealing surface, wherein either the sonotrode or the counter tool is a tool according to claim 1,
c. guiding the material between the sealing surface of the sonotrode and the sealing surface of the counter tool in a feed direction,
d. excitation of the sonotrode with an ultrasonic oscillation, so that the sonotrode applies a pressure via the sealing surface of the sonotrode to the material and the sealing surface of the counter tool, so that the material in the region of the first and second partial sealing surface of the tool is processed with ultrasound.

14. The method according to claim 13, wherein a tool is provided, wherein the first plane is perpendicular to the feed direction.

15. The method according to claim 13, wherein the height H2 of the second elevation is smaller than a total thickness of the two- or multi-layer material to be processed and the height H1 of the first elevation is selected such that the sum of the height H1 and the height H2 is larger than the total thickness of the two- or multi-layer material to be processed.

16. The tool according to claim 2, wherein the first partial sealing surface of the first elevation is either flat, preferably parallel to the base surface, or is curved with a radius of curvature r₁ convex to the base surface, wherein preferably the radius r₁ is greater than the radius r₂ of the second partial sealing surface, wherein the first elevation has a trapezoidal cross-section in a first plane perpendicular to the base surface, and wherein the first elevation and/or the second elevation have an extension in a transverse direction perpendicular to the first plane which is larger than an extension in a longitudinal direction parallel to the first plane.

17. The tool according to claim 16, wherein exactly one second elevation is arranged on the first partial sealing surface of the first elevation, wherein preferably the second elevation is arranged centrally on the first partial sealing surface, wherein a length of the shorter base side of the trapezoidal cross-section of the first elevation corresponds to an extension of the first partial sealing surface in the first plane, and wherein the height H2 of the second elevation is less than or equal to the height H1 of the first elevation.

18. The tool according to claim 17, wherein an extension of the second partial sealing surface in a first plane perpendicular to the base surface is smaller than an extension of the first partial sealing surface in the first plane, wherein a third elevation is provided on the base surface, wherein the third elevation extends with a height H3 in a direction perpendicular to the base surface from the base surface, wherein the third elevation is arranged neither on the first partial sealing surface nor on the second partial sealing surface and is intended to come into contact with the material to be processed, but not to carry out processing of the material, wherein the height H3 of the third elevation corresponds at least to the sum of the height H1 of the first elevation and the height H2 of the second elevation and is preferably larger than the sum of the height H1 of the first elevation and the height H2 of the second elevation, and wherein the tool is a sonotrode or an anvil of an ultrasonic welding device.

19. An ultrasonic welding device, comprising: an ultrasonic generator, a converter, a sonotrode and a counter tool, the converter being set up and connected to the sonotrode in such a way that the converter converts an ultrasonic frequency generated by the ultrasonic generator into a mechanical vibration during operation of the ultrasonic welding device and transmits it to the sonotrode, wherein the sonotrode and the counter tool each have a sealing surface, which comes into contact with the material to be processed during operation of the ultrasonic welding device, wherein the sealing surface of the sonotrode is opposite the sealing surface of the counter tool, wherein between the sealing surface of the sonotrode and the sealing surface of the counter tool a material to be processed can be arranged, wherein either the sonotrode or the counter tool is the tool according to claim 18.

20. The method according to claim 14, wherein the height H2 of the second elevation is smaller than a total thickness of the two- or multi-layer material to be processed and the height H1 of the first elevation is selected such that the sum of the height H1 and the height H2 is larger than the total thickness of the two- or multi-layer material to be processed.
